(19) United States
(12) Patent Application Publication
(10) Pub. No.: US 2009/0048933 A1
(43) Pub. Date: Feb. 19, 2009

(54) ADVERTISING MANAGEMENT AND SEARCHING SYSTEM THROUGH BIDIRECTIONAL SEARCHING AND MONITORING

(76) Inventor: Hyoung-ku Cho, Seoul (KR)

Correspondence Address: HAMRE, SCHUMANN, MUELLER & LARSON, P.C., P.O. BOX 2902, MINNEAPOLIS, MN, 55402-0902, US

(21) Appl. No.: 12/279,038

(22) PCT Filed: Feb. 9, 2007
(86) PCT No.: PCT/KR07/00729

§ 371 Date: Aug. 11, 2008

(30) Foreign Application Priority Data
Feb. 21, 2006 (KR) 10-2006-0016574

(51) Int. Cl. G06Q 30/00; G06Q 90/00

(52) U.S. Cl. 705/14; 705/1

(57) ABSTRACT

Provided is a system for advertisement management and search through bi-directional search of advertisement objects and advertisement companies. The system includes an information storing unit for storing information on individual or seller members, seller information, goods information, advertisement or event information; a search unit for allowing the advertisement requester to search for the advertisement objects; a selecting unit for allowing the advertisement requester to select the advertisement objects corresponding to an input search condition; a confirming unit for allowing the advertisement requester; and an incentive providing unit for providing incentive to the advertisement objects. The seller activity score as the search result order criterion is effective within a predetermined period which depends on an evaluation criterion item, a business type, and a region, thereby maintaining fairness and reliability of the evaluation result.

### TECHNICAL FIELD

The present invention relates to a system for advertisement management and search through bi-directional search of advertisement objects and advertisement companies using wire/wireless communication equipment and through monitoring of advertisement participation situation. More particularly, the present invention relates to an advertisement management and search system capable of maximizing advertisement effects by searching for sellers, goods, or advertisement objects in a rank order and monitoring a participation situation of advertisement recipients.

### BACKGROUND ART

Search services, such as Yahoo, Google, and Naver, which allow users to easily access desired information or sites on Internet are provided. In these search services, a search result is displayed according to importance of information on the Internet. The search result includes information, such as knowledge, a government's homepage, companies' homepage, individuals' homepage, goods, and services, which are associated with a search keyword. The search result display reflects a hit count or a link count, not features of the information. In particular, sellers or goods greatly depend on advertisements, and small offline sellers having no website are excluded from advertisement objects.

Since most of users use theses search services, sellers expects to obtain indirect advertisement effects by exposing search results to the users at additional cost. The sellers may suspend banners or pop-up advertisements to famous homepages having lots of visitors. This advertisement is searched when an individual visits the homepage with advertisements, and a seller registering the advertisement cannot select advertisement objects. Accordingly, this advertisement scheme provides passive advertisement effects. Advertisement cost, which depends on a hit count, is high and paid to service provider.

Meanwhile, examples of typical active advertisements include an E-mail advertisement targeted to website members or unspecified persons, an advertisement in which an advertisement program is used or a specific site address is placed in a registry containing setup information of windows so that users move to the site, and an advertisement based on short message service (SMS) of wireless communication devices or an automatic response system (ARS) of wire/wireless communication devices.

In the E-mail advertisement, an advertisement E-mail is regarded as an illegal spam mail when it is forwarded to non-members. Accordingly, the advertisement E-mail must be forwarded to only subscribed members. To advertise sellers or their goods to unspecified objects, the above-described search service or banners are used. This does not provide cost-efficient effects. In the E-mail advertisement targeted to subscribed members, an advertisement E-mail is allowed to be forwarded to the members without additional cost only if the members agree to receive the mail. However, in recent years, as numerous E-mails are distributed, it is difficult to check whether the members read the E-mail. The SMS advertisement based on a wireless communication device is limited in the number of transmittable characters and accordingly information delivery. Accordingly, advertisement effects are insufficient and cost effectiveness is low.

The ARS advertisement based on a wire/wireless communication device has an advantage of much information delivery in comparison with the SMS, but has disadvantages of difficulties that visual information cannot be provided and the mail cannot be confirmed at a time when a recipient wants, and of low cost-effectiveness.

Further, there are a scheme in which when an individual member visits a specific site, incentive, which differs from a site to a site, is provided to the member, and a scheme in which when a visitor is subscribed as a member, incentive, such as point, is provided to the visitor. These schemes provide low actual advertisement effects since the advertisement is targeted to Internet sites and visitors obtain only incentive by leaving from internet sites as soon as they visit the internet sites. The latter is intended to increases the number of members rather than to advertise in homepages. And, users tend to avoid the subscription since their individual information is exposed.

Conventional search services store search information in database and provide a search result according to importance determined based on a hit count or registration date or on a webpage link count. This increases accuracy of the search result, but not a value of the search result since the services do not consider features of information. For example, a seller registered in lots of search sites or having a high link count has a higher priority than a seller of much sales money and high customer popularity.

In a conventional advertising scheme based on member subscription as shown in FIG. 1, an information consumer 11 directly searches for a website of an advertisement company 10 using a tool such as a web browser and confirms an advertisement on the website, or the information consumer 12 confirms an advertisement provided by an e-mail (14). To obtain cash or cyber money or goods (15) as a return for the confirmation (14) of the advertisement, the information consumer 12 must be known to the advertisement company 10. That is, the advertisement company must obtain personal information of the information consumer 12. Accordingly, this scheme has problems in that the personal information of the information consumer 12 may be maliciously used and it is difficult to recognize the correct number of members since authenticity of the member information entirely depends on the will of the information consumer 12.

Meanwhile, in a conventional scheme of providing a return after recommendation as shown in FIG. 2, an information consumer 22 subscribed as a member to an advertisement company 21 recommends a new information consumer 26 to subscribe as a member (27). When the information consumer 26 agrees to subscribe and confirms an advertisement of the advertisement company 21 (24), the information consumer 22 can obtain a return 25. If the information consumer 26 records the recommender upon subscription (23), the seller provides a return to the recommender 22 (28). In this method, it is wondered whether the new subscriber 26 registers the existing subscriber 22 as the recommender.

To solve this problem, one example of a patent technique is disclosed in Korean Patent No. 10-478999 (registration date: Mar. 17, 2005) entitled “Information Providing Method having Authentication Agent on Internet and Embodying System therefor.”

In the patent, an information, agent provides information contents of an information provider to an information consumer on a network. In this case, an authentication agent as a software agent having the information contents and an authentication key performs information consumer authentication without exposing individual information of the information consumer, such as member subscription information. The authentication can be performed for the information consumer without requiring the information consumer to open individual information, such as member subscription information. Accordingly, the information consumer can receive and distribute the information with a return without burden, purchase goods, and obtain a return for information consumption, such as cash. An information provider and an information agent measure objective information supply and demand for transaction. This enables Internet advertisement, research, distribution, sales, entertainment, payment, authentication, etc.

A method and apparatus for custom advertisement using a quiz is disclosed in KR Patent Laid-open Publication No. 2001-70681 (Publication Date: Jul. 27, 2001).

In this technique, an advertisement is selected according to a certain condition and is performed through a quiz using the Internet, mobile phone or IMT 2000 terminal. The quiz-based advertisement method includes creating an ordinary member database, setting advertisement object conditions and prize money provision criteria, searching for ordinary members corresponding to advertisement object conditions, and notifying the ordinary members that there are advertisements. When the ordinary member accesses a server, the target advertisement is searched and the advertisement is provided to the ordinary member together with prize money information and the quiz. An advertisement effect is analyzed based on a response to the quiz, advertisement cost is calculated, and the prize money is provided to the ordinary member.

However, the conventional search and advertisement method disclosed in the above patents have advantages of high reliability of a search result through concurrent or independent information search and advertisement, and high advertisement effects. The search result can be associated with the advertisement and the search result can be provided with high accuracy. However, the method does not provide sufficient importance criterion for commercial information. The conventional advertising method is suitable for extensive advertisements, but not for advertisement targeted to a few users, such as small sellers, as objects. With the method, suitable objects cannot be selected and such a selection is costly and less efficient. E-mail or SMS, which is directly forwarded to individual private boxes of subscribed members, may not be read by being considered as SPAM, thus degrading advertisement effects.

### DISCLOSURE

### Technical Problem

It is an object of the present invention to provide an advertisement managing and search system, which allows a seller to check its level and advertise positively and actively through search of desired objects by building a portal site with search and advertisement functions according to an order for online and offline stores.

It is an object of the present invention to provide an advertisement managing and search system, which allows to obtain members' evaluation, opinions and complaints, allows a seller to determine and provide advertisement cost according to advertisement effects, allows individuals to search for and participate in excellent sellers, goods or events according to dwelling environment, hobby, and the like, allows participants to obtain a part of advertisement cost as a return according to a participation degree, and allows the seller and individuals to manage all processes including advertisement and purchase using an advertisement management system, so that purchaser participation information, seller evaluations purchase result, and seller advertisement investment cost are used to determine a priority of a bi-directional searching result.

### Technical Solution

One aspect of the present invention provides an advertisement management and search system through bi-directional search of sellers and purchasers and through monitoring of advertisement situation, for allowing a seller, i.e., an advertisement requester to search for and select advertisement objects over a network, allowing the system to monitor the selected advertisement object viewing an advertisement and purchasing goods, represent the advertising process as a numerical value, determine advertisement cost based on the numerical value, and reflect the numerical advertisement result to scores of the advertisement object and the advertisement requester, and allowing all members or non-members to search for sellers and goods and the advertisement requester to search for advertisement objects based on the scores, the system comprising: an information storing unit for storing information on individual or seller members, seller information, goods information, advertisement or event information, and result information for advertisement and purchase activities; a search unit for allowing the advertisement requester to search for the advertisement objects and allowing the advertisement objects and all members or non-members to search for seller information, goods and advertisement, based on the information stored in the storing unit; a selecting unit for allowing the advertisement requester to select the advertisement objects corresponding to an input search condition, the advertisement objects to select desired seller and goods advertisement, and ordinary users to search for and select desired sellers, goods, and advertisement; a confirming unit for allowing the advertisement requester to confirm seller information, advertising state, type-specific participation state of the selected advertisement objects, and advertisement results, all the members to confirm member information, advertising steps in which the members participate, and participation results, and the members or non-members to conform the searched seller, goods, and advertisement information; and an incentive providing unit for providing incentive to the advertisement objects according to the steps in which the advertisement objects participate.

The system may further comprise a managing unit for calculating and managing scores for participation steps, including individual's detailed advertisement confirmation, reservation request, pre-payment, purchase, questionnaire participation, and breaking information, in addition to general member information, and calculating and managing scores for seller's investment cost, investment number, individual's evaluation score, and individual's hit count. The managing unit may selectively or sequentially manage advertisement object participation steps including an object notification step, a detailed content confirmation step, a reservation step, a pre-payment step, a purchase step, a questionnaire step, in addition to general advertisement information, and the information can be selected by the selection unit upon advertisement request and used to calculate advertisement cost and determine an advertisement form.

The managing unit may allow the advertisement requester to search for and select desired advertisement objects, designate an object number, designate an advertising period and an object number in the period in consideration to features of sellers and goods, designate an advertisement object notification method, an advertisement reception confirmation method, and an advertising step, designate incentive and participation score of each designated step, designate reservation, pre-payment, and payment means, and participation conditions upon purchase including action information, a payment way, and a check way according to the designated advertising steps, and designate a questionnaire question number, a type, and a content when registering the advertisement, so that the advertisement requester selects various criteria according to the advertising steps. The advertisement requester may check advertisement cost calculated based on the designations, and request to register the advertisement, and the managing unit may check validity of the input data to approve, cancel and supplement the requested advertisement depending on the advertisement content.

The search unit may allow the advertisement requester to search for and select the advertisement objects based on the information stored by the storing unit, allow the advertisement object to search for a desired advertisement, and allow all the members and non-members to search for and select sellers, goods information, or ongoing event information. When conditions input upon the advertisement requester searching for the advertisement objects are the same, preferential objects may be selected based on the score of advertisement objects within the object number designated by the advertisement requester using the managing unit, and when there are several search results corresponding to the same search conditions upon all the members and non-members searching for the seller, goods, or advertisement information, the search results may be listed according to priorities based on the seller score.

The scores of the advertisement objects and the advertisement requester may be values reflecting a participation degree of the members, and the managing unit may give a right for the score to the advertisement objects and the advertisement requester in order to induce participation of the advertisement objects and the advertisement requester, such that the advertisement objects and the advertisement requester obtain incentive corresponding to the scores, sell the scores to another member, or sell the scores within reference price through the management system upon withdrawal.

The confirming unit may notify advertisement objects selected by the selecting unit that they are advertisement objects, and the advertisement objects may participate the advertising steps designated by the advertisement requester, and follow a designated confirmation procedure for each step. When the confirmation is approved by the confirmation unit, the advertisement requester may provide the designated incentive to the advertisement objects and reflect the participation score.

The incentive providing unit may confirm whether the advertisement objects participate in the purchase through advertisement object check in which, upon purchase, the advertisement objects directly register whether to purchase goods using an authentication number received from the advertisement requester according to action information as a participation condition designated by the advertisement requester, through advertisement requester check in which the advertisement requester accesses a management homepage to register that the advertisement objects participate, or through system check in which, upon purchase, payment information or goods information is provided by an affiliated company and registered, and may provide incentive to the advertisement objects.

The payment information paid by the providing unit may be reflected to expenditure specification of the advertisement objects and to revenue specification of the advertisement requester, so that the expenditure and revenue specifications are provided to the respective members. The payment information may be modified, deleted or not opened in response to each member's request. The managing unit allows to input separate revenue or expenditure repeatedly or irregularly in order to provide a function of an electronic housekeeping book. Thus, the members can manage assets after purchase.

Furthermore, the managing unit allows the individual members to inquire sellers or goods and event information using the search unit and to view an introduction page of each seller, thereby providing a community function.

### ADVANTAGEOUS EFFECTS

As described above, with the bi-directional searching advertisement managing and search system according to the present invention, individuals can obtain, through search, excellent sellers or service, goods information based on rank information and evaluation information for the sellers or goods that are not provided by existing search service according to objective criteria. The sellers can advertise their excellent products by means of search results. The use of the advertisement function enables a high rank seller to increase sales money through latent customers, and a low rank seller to increase the rank by advertising the seller and increasing sales money.

Furthermore, according to the present invention, the sellers can obtain a hit count and a visit number by all members, opinions on advertisements or introduction pages, members' demands, participation degree, visit number, etc. in real time, so that the sellers utilize them as reference data for events or advertisements. Sellers or foundation preparing members can obtain management-related consulting information, such as foundation business type or region selection, region- and business type-specific marketability, future market's direction, primary-customer analysis, purchase propensity analysis, competition seller analysis, etc.

### DESCRIPTION OF DRAWINGS

FIG. 1 is a block diagram illustrating a conventional advertising scheme of providing a return for advertisement confirmation when member subscription is made;

FIG. 2 is a block diagram illustrating another conventional advertising scheme of providing a return for subscription recommendation when member subscription is made;

FIG. 3 is a block diagram illustrating an advertisement registration and performing procedure for seller, goods, or events in an advertisement management system according to an embodiment of the present invention;

FIG. 4 is a flowchart illustrating a registration and participation procedure in an advertisement management system according to the present invention; and

FIG. 5 is a flowchart illustrating a processing procedure when an individual member participates in a registered advertisement according to the present invention.

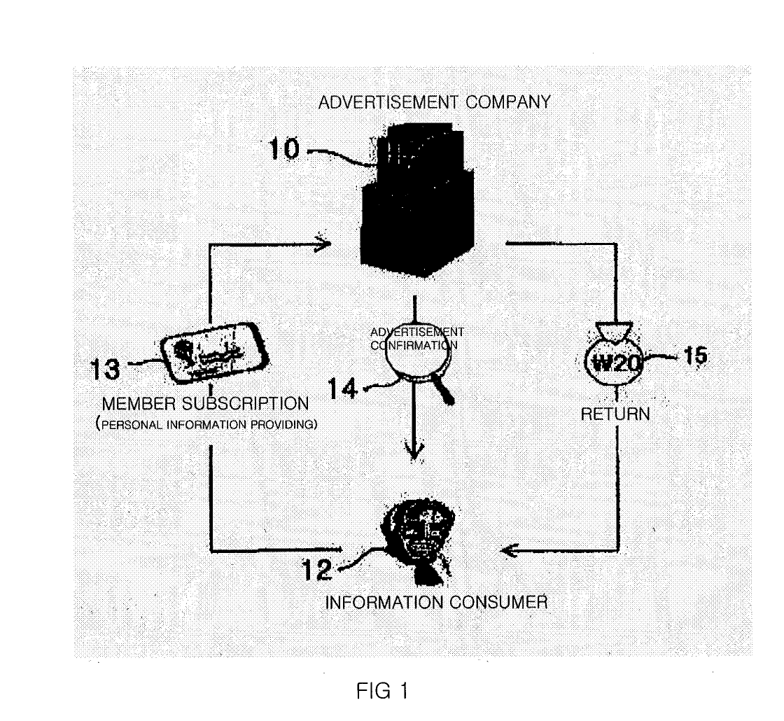

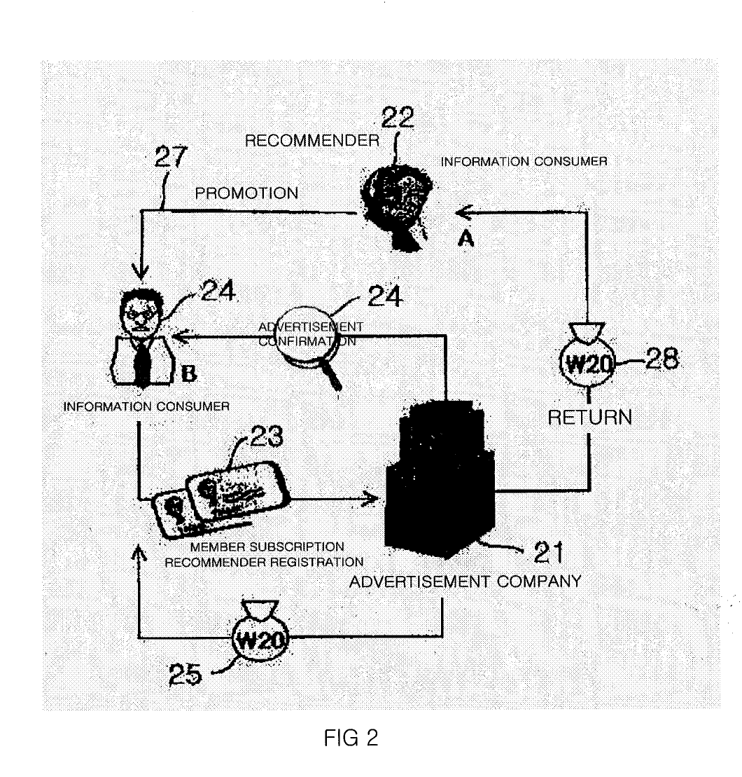

### MODE FOR INVENTION

Hereinafter, exemplary embodiments of the present invention will be described in detail. However, the present invention is not limited to the exemplary embodiments disclosed below, but can be implemented in various types. Therefore, the present exemplary embodiments are provided for complete disclosure of the present invention and to fully inform the scope of the present invention to those ordinarily skilled in the art.

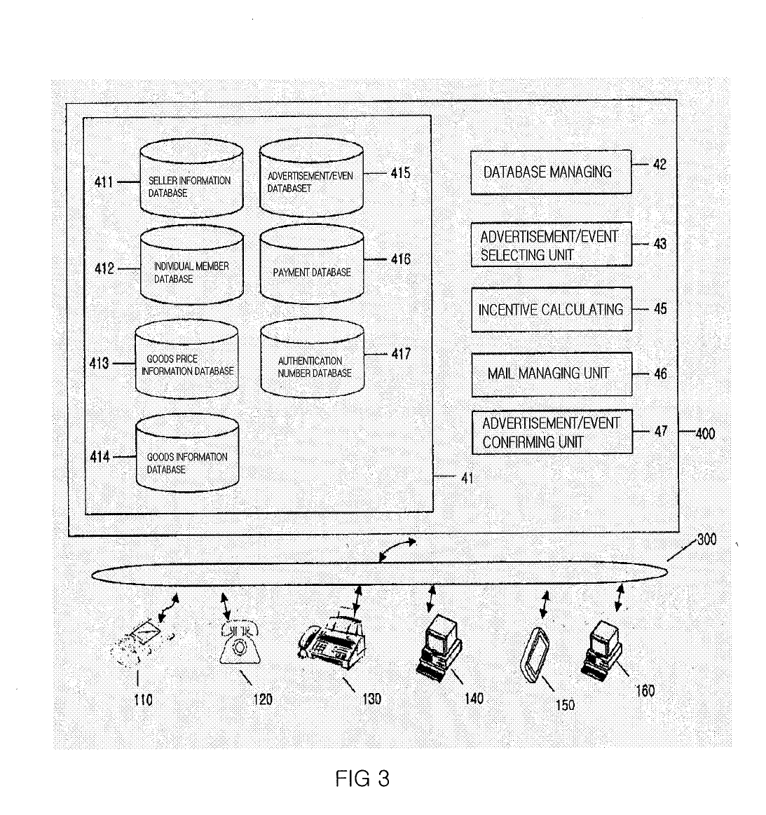

FIG. 3 is a block diagram illustrating an advertisement registration and performing procedure for seller, goods, or events in an advertisement management system according to an embodiment of the present invention.

In FIG. 3, 110 indicates a mobile phone carried by an individual member and enabling advertisements, events, or questionnaire, 120 indicates a phone enabling questionnaire by ARS voice, 130 indicates a facsimile, 140 and 150 indicate a personal computer (PC) and a personal digital assistant (PDA) capable of accessing the Internet, respectively. 110 to 150 indicate individual member systems. 160 indicates a seller member system which includes a personal computer capable of accessing the Internet and enables to check a result of advertisements, events and questionnaire, purchase, and the like. 300 indicates a network which provides an information transmission path among the mobile phone 110, the phone 120, the facsimile 130, the PC 140, the PDA 150, and the seller system 160. 400 indicates a service center and a manager system comprising a web server which supports one or more clients and constitutes a web.

In FIG. 3, the management system comprising the web server 400 includes a database 41 for storing member information and goods information, a database managing unit 42 for managing the information stored in the database 41, an advertisement/event searching and selecting unit 43 for selecting a desired advertisement or event while performing advertisements, events, and questionnaire, an incentive calculating unit 45 for calculating incentive generated due to participation action, such as detailed advertisement content confirmation, goods purchase, questionnaire, and the like, a mail managing unit 46 for delivering results of advertisements, events, and questionnaire to subscribed sellers via E-mails, and an advertisement/event confirming unit 47 for confirming whether individual members view or participate in an advertisement or event of the seller member.

The database 41 comprises a seller information database 411 for storing detailed seller information including homepage advertisement investment, evaluation information, and sales information; an individual member database 412 for storing participation degree and personal information of individual members who participate in advertisements, events, and questionnaire; a goods price information database 413 for storing information on price of goods of seller members; a goods information database 414 for storing information on goods of seller members; an advertisement/event database 415 for storing information on advertisements or events that the seller members provide to individual members; a payment database 416 for allowing the members to purchase the goods; and an authentication number database 417 for verifying that the individual members participate in advertisements, events, and the like.

The seller system 160 has been described as being the personal computer. The seller system 160 is not limited thereto and may be an Internet terminal or a personal digital assistant capable of accessing a server.

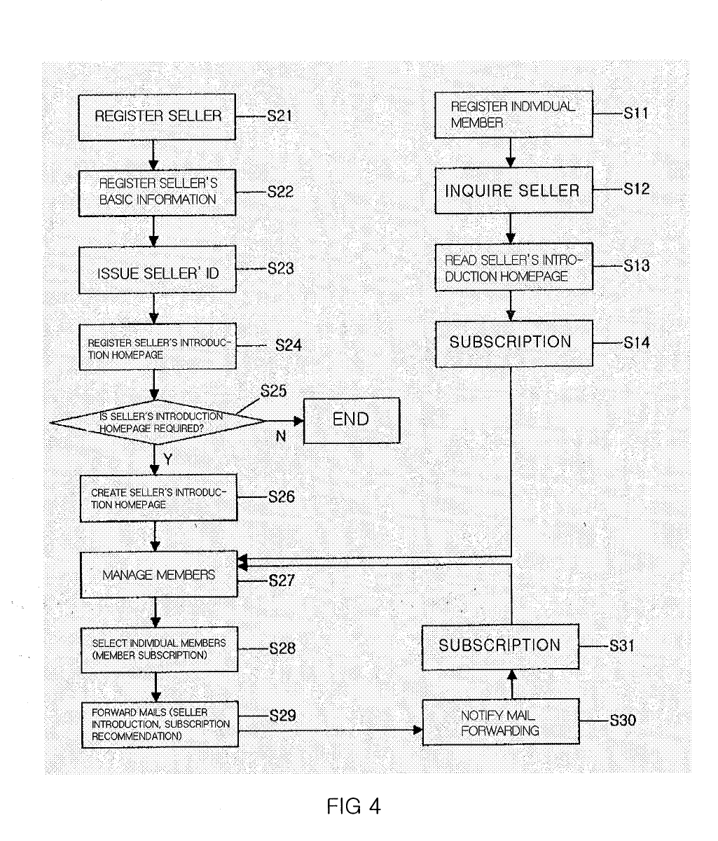

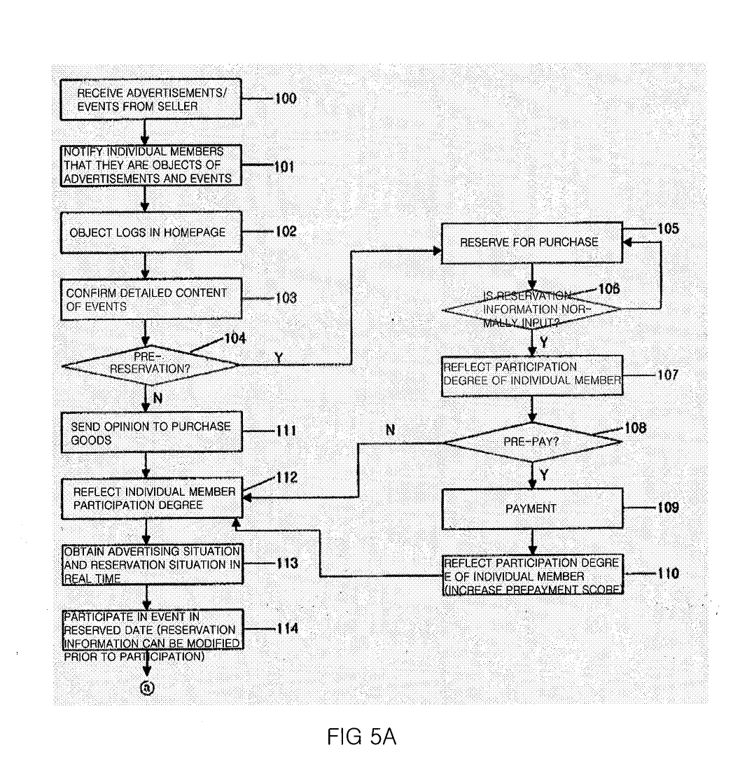

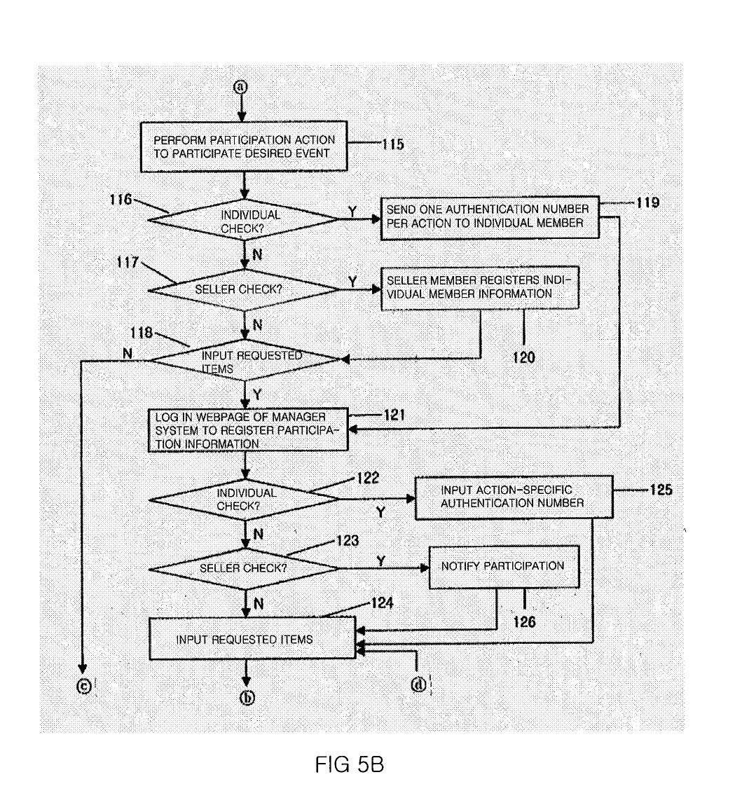

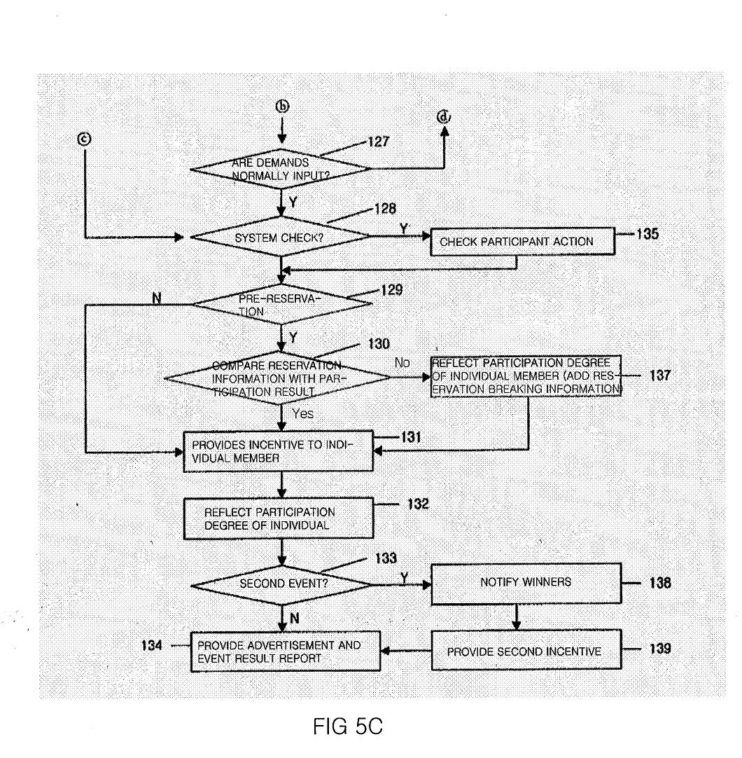

An advertisement management method according to an embodiment of the present invention will now be described with reference to FIGS. 4 and 5.

FIG. 4 is a flowchart illustrating a registration and participation procedure in an advertisement management system according to the present invention

To participate in advertisements, events and questionnaire, an individual member accesses the Internet by using the mobile phone 110, the telephone 120, or the facsimile 130, or by executing a search tool, i.e., a web browser on the PC 140 or the PDA 150. The device is connected to the web server 400 in a service center and a web page is displayed.

When the individual member is connected to the web server 400 via the Internet using its member system, the web server 400 performs a login step through an individual member ID input area and a password input area on a webpage (S11).

In the login step, a determination is made as to whether the individual member is a subscribed member who is allowed to participate in advertisements, events, and questionnaire. When the individual member is an unsubscribed member, he/she is led to a member registration process.

The unsubscribed member is allowed to access rank information of sellers or goods. The web server 400 receives individual's basic information, detailed information, and advertisement requester selection information from the individual member desiring to participate in the advertisements, events, and questionnaire.

The basic information is stored in individual member information database 412. The basic information includes ID, password, resident registration number, home/company address, phone number, mobile phone number, E-mail address, mobile phone message reception or non-reception, mail reception or non-reception, etc., as shown in Table 1. The detailed information includes hobby, occupation, smoking status, dwelling form, concerned field, academic background, employment type, etc., which become conditions for selecting objects of the advertisements, events, and questionnaire.

TABLE 1
Individuals' basic registration information

| Individual | Individual | Resident registration | | | |
|---|---|---|---|---|---|
| ID | Password | number | Home/company | Mobile phone | Others |
| Hong Gil- | ****** | ******-******* | Jongno-gu, Seoul | 010-111-1111 | |
| Dong | | | | | |
| . . . | . . . | . . . | . . . | . . . | . . . |

After a user is registered as the individual member in step S11, he/she inquires a desired seller according to types, such as a desired region, business type, and the like (S12).

The individual member views seller name, business type, address, phone number of the seller inquired and searched using the individual member system on a seller introduction page created by the seller member system. The individual member determines whether to subscribe to the seller member and subscribes to the seller member when he/she wants (S14).

In the present invention, the advertisement/event selecting unit 43 allows the individual member to assign a priority to a desired advertisement, event or seller type in consideration of individuals' evaluation to an advertisement requester as a seller member, advertisement or event type, advertisement or event period, etc.

Further, a seller member desiring to register is subject to a login step through a member ID input area and a password input area on the webpage of the web server 400 (S21).

In the login step, a determination is made as to whether the seller member is a registered seller, and when it is a new seller, the seller member inputs its own basic seller information (S22).

When the seller inputs the basic information in step S22, the basic information is stored in the seller information database 411. The basic information includes ID, Password, business registration number and corporate registration number, address, phone number, business type, e-mail address, mobile phone reception or non-reception, mail reception or non-reception, etc., as shown in Table 2.

TABLE 2
Sellers' basic registration information

| Seller | Seller | Seller | Seller | Seller | |
|---|---|---|---|---|---|
| ID | Password | type | name | address | Others |
| C001 | ****** | A | E-MART | Guro-gu, | . . . |
| | | | | Seoul | |
| C002 | ****** | B | Seolleongtang | Songpa-gu, | . . . |
| | | | restaurant | Seoul | |
| . . . | | | | | |

The seller information stored in Table 2 is processed by the database managing unit 22 according to the seller type, managed as seller type registration information as in Table 3, and stored in the seller information database 411 of the database 41.

TABLE 3
Sellers' type registration information

| Seller type code | Seller type | Others |
|---|---|---|
| A | Distribution | |
| B | Restaurant | |
| C | Manufacture | |

When the seller subscribes as a member, the web server 400 creates a seller introduction page depending on the basic information.

Specifically, the web server 400 stores seller introduction information aligned by seller types in the seller information database 411 so that seller introduction, sketch map, and the like provided by the seller system 160 are displayed (S24).

That is, the web server 400 inquires the subscribed seller member as to whether it desires to have the seller introduction page (S25). When the seller member desires to have the seller introduction, the web server 400 creates the seller introduction page depending on the information input in step S24 (S26).

When the seller member does not desire to have the seller introduction page, the database managing unit 42 manages only the seller's basic information and ends processing other seller introduction information.

The database managing unit 42 then manages, through the mail managing unit 46, the individual members subscribed on the seller introduction page created by the web server 400 so that the individual members participate discount coupons issued by the seller member or advertisement, event questionnaire, etc. (S27).

Here, the seller member is the member registered in step S24, and the registered seller issues the discount coupon to the subscribed individual members or sends an invitation to participate in a seller's event via the mail managing unit 46.

The seller member also searches for conditions such as address, gender, age, participation score, and the like of individual members subscribed to the system according to the present invention, from the individual member information database 412 of the database 41, and selects members who are likely to subscribe as sellers' individual members (S28).

The mail managing unit 46 then sends a mail including seller introduction and subscription recommendation to the individual members selected in step S28 (S29).

The advertisement/event confirming unit 47 notifies the seller member that an object notification mail has been forwarded to advertisement objects via the mail managing unit 46 (S30).

When the individual members selected in step S27 read the mail and register as the seller's individual members (S31), the process proceeds to step 27, where the members are managed as the seller's members.

A processing procedure for the seller members and individual members subscribed in FIG. 4 will now be described with reference to FIG. 5.

FIG. 5 is a flowchart illustrating a procedure of performing an advertisement, event, and questionnaire in a seller member according to the present invention.

Referring to FIG. 5, the web server 400 receives advertisements, events, and questionnaire from the seller member via the seller system 160 (S100).

The manager system checks validity of the received advertisement data. When the data is normal, the data is sent to an examiner, which rechecks and approves an advertisement content. The manager system notifies the individual members registered to the seller member or individual members selected by the web server 400 that they are objects of advertisements, events and questionnaire, on a desired date upon a seller member's demand (S101).

The seller member performs an event on latent individual members corresponding to the conditions such as region, age, gender, etc. of VIP individual members or non-VIP members using the seller system 160 in order to lead the members to subscription as VIP individual members.

The individual members subscribed to the seller or individual members selected by the web server 400 in step S31 are subject to a login step, where they input their ID and password on the webpage of the web server 400 through the individual member system and the mail managing unit 46 shown in FIG. 3 in order to participate in the advertising step (S102).

The individual members logging in step S102 checks detailed contents of the advertisements, events, and questionnaire of the seller member, which are configured of moving images, texts, and images of the webpage on the web server 400 (S103).

Then, the registered seller determines whether the individual member confirming the detailed content of the advertisement in step S103 makes a pre-reservation (S104).

The individual members who do not make a reservation in step S104 is asked as to whether to purchase goods through advertisements or events stored in the goods information database 414 (S111). The individual member participation degree is reflected and the incentive is provided as a return for the confirmation of the detailed information of the advertisements and events (S112).

In the present invention, the incentive includes cash; goods ticket, point, or free gift corresponding to the cash; and the like.

Further, when a participating individual member comes with friends or neighbors or purchases lots of goods, he/she is provided with more incentive, thereby advertising the neighbors of the individual member and increasing sales money.

The subscribed seller obtains statistical data, such as advertising situation, reservation situation, detailed information confirmation situation, goods purchase, payment, reservation breaking, and the like, on the webpage in real time through the advertisement/event confirming unit 47 and the mail managing unit 46 (S113).

The individual member participates in the event in a possible period or reserved date or time according to the priority assigned by the advertisement/event selecting unit 43 (S114). When participating in the event, the registered individual member is requested to reserve, and can modify the reservation information before the reserved date. When the reservation information is more than the purchase information, this case is considered as reservation breaking. When the reservation information is less than the purchase information, this case is also considered as reservation breaking since the reservation information is not modified, thereby inducing correct reservation by the individual member and increasing stability in seller productivity and event preparation. When the seller is sensitive to the event preparation, reservation breaking is set to a maximum value. On the other hand, setting the reservation braking to a smaller value provides convenience to the seller and the individual member.

When the member does not reserve, he/she may confirm the detailed content and visit an online or offline store to participate in the event, and may reserve, if necessary.

Further, when it is determined in step S104 that the individual member reserves, the seller receives member participation date, participant number, participation time, purchase content, etc. (105).

When the reservation information is normally input (S106), this activity is reflected to the participation degree of the individual member (S107). When the activity is not reflected, the re-reserving individual member re-makes a reservation for participation date, participant number, participation time, purchase content. When they are normally input, the activity is reflected to the participation degree of individual member and the incentive calculating unit 45 provides incentive to the member.

When the subscribed individual member determines to purchase goods stored in the goods information database 414 by referring to advertisements, events, and questionnaire, the seller determines whether the member desires to pre-pay (S108), and performs a payment process when the member desires to pre-pay (S109). The process proceeds to step S112 when the member does not desire to pre-pay.

After the payment in step S109, the activity is reflected to the participation degree of the individual member and incentive is provided to increase the prepayment score (S110). And, the process proceeds to step S112.

Accordingly, according to the present invention, it is possible for the seller member to manage the type-specific event participation degree of individual members.

The advertisement participation degree of individual members is considered as a participation degree of individual members by the advertisement/event confirming unit 47. Here, a number of times the members log in the webpage on the web server 400 may be translated into the score and a number of times the individual members confirm seller member's introduction data may be translated into the score. And, they are reflected to the participation degree. Upon performing the event and advertisement, it is considered as the event participation of the individual members. When the individual members notified of being the event objects log in the management system and confirm the detailed content, a record or score indicating that the individual members confirm the detailed content is stored. Upon inputting reservation, a reservation score, a reservation breaking score, and a purchase participation score are stored.

According to the present invention, the participation degree of individual members are managed according to steps of event object selection, detailed information confirmation, reservation pre-payment, purchase, and questionnaire participation, as shown in Table 4. This information may be provided to the seller members to be referenced for object selection.

TABLE 4
Event participation degree management information

| | Seller | Event | Detailed | | | | | |
|---|---|---|---|---|---|---|---|---|
| Individual | type | object | information | | pre- | | Questionnaire | reservation |
| ID | code | selection | confirmation | reservation | payment | purchase | participation | breaking |
| AAA | A | 30 | 25 | 3 | 2 | 10 | 5 | 2 |
| AAA | B | 40 | 20 | 4 | 0 | 0 | 0 | 4 |
| BBB | A | 50 | 50 | 0 | 0 | 15 | 0 | 0 |
| . . . | . . . | | | | | | | |

It can be seen from Table 4 that individual member AAA has received, thirty times, a notice that distribution seller member A selected individual member AAA as an event target. And, individual member AAA confirms detailed information twenty-five times.

This fact is recorded when the seller member forwards an event object selection mail to individual members via the mail managing unit 46, and when the individual member logs in the seller member's management home page and confirms the detailed information of the event, this activity is recorded and managed by the advertisement/event confirming unit 47.

In Table 4, the reservation is made when the reservation is available, the pre-payment is made when pre-payment is available, the purchase is recorded after a purchase result is reflected, and the questionnaire participation is made when questionnaire participation is available.

Further, the reservation breaking is recorded and managed by the advertisement/event confirming unit 47 when the reservation information is broken instead of being canceled.

The manager system may provide different incentive to individual members in the order of purchase number>questionnaire participation number>pre-payment>reservation breaking (small value)>reservation>detailed information confirmation. The seller member may perform reselection according to the participation type of the selected individual member.

In step S114, the individual member performs a participation action to participate the desired event on a possible period or reservation date (S115).

The participation action refers to purchasing one or more of goods provided by the goods information database 414, suggesting purchase price provided by the goods price database 413 as a minimal price, performing payment with a credit card upon purchasing the goods, and accepting demands of the seller member upon purchasing, including having to purchasing any goods.

When the individual member pays with the credit card, data provided by a tie-up insurance seller may be used, and goods to be purchased may be known with ubiquitous radio frequency identification (RFID).

The RFID refers to a technique of processing information on objects using small semiconductor chips, which are attached to various products. The RFID is a contactless recognition system that sends and processes object information and environment information using a radio frequency.

The action information of the individual member may be selected by the seller member and an example thereof is shown in Table 5.

TABLE 5
Participant action information type

| Action type code | Action type name | Others |
|---|---|---|
| A00 | No participation action | |
| A10 | Goods purchase | |
| A20 | Card payment | |
| A30 | Point saving | |

When in order to verify event participation, the individual member selects individual check in which an authentication number, such as a number or character, in the authentication number database 417 suggested by the seller member is provided (S116), the seller member sends one authentication number per action to the individual member via the mail managing unit 46 (S119). The process then proceeds to step S121.

When the individual member selects seller check in which the seller member logs in the webpage and records participation information, not the individual check (S117), the seller member registers the individual member information (S120). And, the process proceeds to step S118.

When the individual member does not select the seller check in step S117, he/she determines whether to input an item requested by the seller member (S118) and logs in the webpage of the manager system to register the participation information when the individual member determines to input the item (S121).

When the individual member determines not to input the item in step S118, the process proceeds to step S128. In this case, the individual member accesses the webpage of the manager system via a wire/wireless communication device shown in FIG. 3 and the ubiquitous-based seller member system.

After registering the participation information in step S121, a determination is made as to whether the individual member selects the individual check (S122). When it is determined in step S122 that the individual member selects the individual check, action-specific authentication number provided by the authentication number database 417 is input (S125). When the individual member does not select the individual check, the seller check is used (S123). When it is determined in step S123 that the individual member selects the seller check, the individual member is notified of being participated (S126).

When the individual member does not select the seller check in step S123, the individual member inputs seller demands such as the event participation questionnaire (S124). When the demands are normally input (S127), the system check is performed, in which information on member action, such as an RFID or a credit card is checked (S128). When the demands are not normally input (S127), the process returns to step S124, where reprocessing is requested to the individual member. When the individual member selects the system check in step S128, the action information of the individual member is checked (S135), and the process proceeds to step S129.

According to the present invention, each action type includes additional condition types, as described later. When the individual member purchases goods by referring to the information stored in the goods information database 414, he/she can designate to purchase one or more goods, goods more than predetermined goods, or specific goods. When the seller member induces non-related person's participation, the seller member may designate the participant number. When the individual member does not desire to purchase, he/she may not designate a participation action.

In the present invention, the minimal money designation is made by the seller member, the specific-goods designation can be made when the specific goods can be recognized through an RFID technique, and participant number designation is to designate minimal participant number. In the case of individual authentication, the minimal participant number is input by obtaining an authentication number corresponding to the participant number from the seller based on the information stored in the authentication number database 417. In the case of seller authentication, the seller member logs in the webpage on the manager system and inputs the participant number. The system authentication is possible when participant number information can be provided by the affiliated company. The designation ways are shown in Table 6.

TABLE 6

| Action additional | | |
|---|---|---|
| condition code | Action additional condition name | Others |
| AA01 | One or more goods purchase | |
| AA02 | Minimal money designation | |
| AA03 | Specific goods designation | |
| AA04 | Participant number designation | |

In step S128, the system check uses card payment or online payment (electronic payment), in which information provided by a banking and payment affiliated company is used for comparison, thereby obtaining the same effect as in the individual check or the seller check.

In step S128, when demand processing is abnormally completed, the seller member performs pre-reservation, if required (S129) and compares reservation information with a participation result (S130). The incentive calculating unit 45 provides incentive to the individual member according to the seller's providing criterion, such as purchase money, participant number, and purchase goods (S131).

When the pre-reservation is not made in step S129, the process proceeds to step S131.

When it is determined in step S130 that the individual member's reservation information is different from the participation result, the reservation breaking information is added according to the participation degree of individual member (S137). The process then proceeds to step S131.

When the individual member does not participate within the reservation period after reservation, check is performed in units of day, week and month, and the participation degree of individual member is reflected to increase the breaking information depending on the reservation information.

Then, the participation degree of individual member is reflected to increase the participation score (S132).

The seller member then inquires the individual member to participate the second step event via the mail managing unit 46. When the individual member requests to participate in the event selected via the advertisement/event selecting unit 43, winners selected according to a designated selection criterion is notified and processing time, purchase money, participation degree score, and input data are provided as basis data (S138).

A second incentive is provided to the winners of the individual members notified in step S138 (S139).

According to the present invention, the incentive calculated by the incentive calculating unit 45 is referenced to determine priorities of event participants or to provide the second incentive, such as free gift, to the participant after event termination.

For example, incentive determined by the seller member, i.e., a requester is provided to each event participant as a return of the event participation. In the second incentive event targeted to the incentive receivers, a gift is provided to tenth and 100-th individual members, i.e., purchasers.

When the individual member does not participate the second event in step S133, the web server 400 create a report on member's additional input information, such as questionnaire information or visit opinion, advertisement, event participant type, participation rate, incentive providing state, reservation state, and reservation breaking state, and provides the report through the webpage on the manager system in real time or provides the report in the form of a print to the seller member, in response to termination of the advertisement and event period or seller member's request (S134).

The result report may have several forms based on event registration information shown in Table 7.

TABLE 7

| Seller ID | CC01 | CC02 |
|---|---|---|
| Eventide | E01 | E02 |
| Event name | Opening event | Opening event |
| Event start date | 2005 Oct. 01 | 2005 Oct. 10 |
| Event end date | 2005 Oct. 30 | 2005 Nov. 10 |
| Individual's participation limit (day) | 3 | 7 |
| Detailed information source | Moving image | HTML |
| Total participant number | 9000 | 1000 |
| participant number | 900 | 250 |
| Action type | A30 | A10 |
| Action additional condition value | AA02 | AA01 |
| Reservation status | 3000 | 0 |
| Pre-payment status | N | Y |
| Questionnaire status | N | Y |
| Others | N | Y |

That is, in the present invention, when a seller member event is registered, the members are selected to designate a total participant number, and an event start date and an end date are designated.

For example, in Table 7, C001(E-MART) performs an opening event for one month, in which total 9000 persons can participate, 900 persons for three days. The purchaser must purchase one or more goods corresponding to more than thirty thousand won through various payment ways and a point card. Reservation and pre-payment are impossible, and the questionnaire is not performed.

CC02 (Seolleongtang restaurant) performs an opening event for one month, in which total 1000 person can participate, 250 persons per one week. Each member takes one or more Seolleongtang through reservation and pre-payment, and participates in the event or restaurant questionnaire.

The seller member may perform designation according to the action type when registering the event and the individual participants can confirm the seller member advertisement from the detailed information.

When the designated action is performed, the incentive or participation degree score is reflected through the individual check, seller check, or system check.

The individual-specific event participation score is provided as the event object selection criterion to increase the likelihood of object selection. Each seller provides the second incentive, such as a discount coupon, a free taste ticket, and gift, to high-outcome members, leading to consistent member concern.

In the system according to the present invention, the seller member incentive may be designated in several steps as in Table 8.

TABLE 8
Incentive providing step information

| Incentive providing | | |
|---|---|---|
| step code | Incentive providing step | Others |
| L01 | Event object winning | |
| L02 | Detailed advertisement confirmation | |
| L03 | Reservation request | |
| L04 | Pre-payment processing | |
| L05 | Purchase | |
| L06 | Questionnaire participation | |
| P01 | Reservation breaking | |

The member may also designate the incentive provision criterion as in Table 9.

In Table 9, in the case of participant number (LA01), individual authentication is applied in which authentication numbers of individual members are input for processing or seller authentication is applied in which a seller inputs the participant number.

In the system check, the affiliated company receives information on the participant number and performs processing through comparison, and provides incentive of each step to the authenticated participants.

Incentive corresponding to purchase case number and purchase money is provided based on payment number or paid money. The Product number is authenticated like the participant number or provided from affiliated companies via RFID.

Table 9 shows incentive provision criterion type information.

TABLE 9
Incentive provision criterion type information

| incentive providing | | |
|---|---|---|
| type code | Incentive providing type | Others |
| LA00 | Not related | |
| LA01 | Person | |
| LA02 | Purchase case number | |
| LA03 | Purchase money | |
| LA04 | Product number | |

The seller member can designate an incentive providing rule, as in Table 10. In Table 10, E01 (E-MART opening event) was input to provide incentive for event object winning, detailed advertisement confirmation, purchase, and questionnaire participation.

The rule was designated so that 10 won is provided when the event object wins, 20 won is provided when detailed information is confirmed, and money corresponding to 10% of purchase money is provided when products are purchased.

The rule is designated so that 2,000 won is provided for each 10,000 won when 10,000 is input as the incentive providing criterion value and 2,000 won is input as the criterion amount.

Further, the rule is designated so that 500 won is provided upon questionnaire participation.

Table 10 represents seller-specific event incentive management.

TABLE 10
Event incentive management for Sellers

| | Incentive | Incentive | Incentive | | Incentive |
|---|---|---|---|---|---|
| Event | providing | provision | providing | Incentive | criterion |
| ID | step code | criterion type | reference value | type code | money |
| E01 | L01 | LA00 | 1 | Won | 10 |
| E01 | L02 | LA00 | 1 | Won | 20 |
| E01 | L05 | LA03 | 1 | % | 10 |
| E01 | L06 | LA00 | 1 | Won | 500 |

Furthermore, the individual member may inquire or receive, via a mail, incentive information provided after event participation via the homepage of the manager system or the mail managing unit 46. The incentive may be managed in detail for each event and seller, or a total money such as total reserve money, expenditure money, and current reserve money may be managed.

Further, in the system according to the present invention, when seller member-registered advertisement ends, a statistical score for advertisement request by the seller member, which is defined in the management system, is reflected.

Table 11 shows advertisement investment activity degree of sellers.

TABLE 11
Advertisement investment activity degree of sellers

| | | | | Incentive | | | |
|---|---|---|---|---|---|---|---|
| | | | | Total | Average | | |
| | Adver- | Partici- | Evalu- | provided | provided | | |
| Seller | tisement | pant | ation | money | money | Total | Total |
| ID | number | number | score | (Won) | (Won) | score | class |
| CC01 | 2 | 3742 | 286 | 5340000 | 1200 | 230 | 10 |
| CC02 | 1 | 650 | 51 | 623000 | 980 | 34 | 20 |

The advertisement request number of CC01(E-MART) is 2, the actual participant number is 3,742, a sum of evaluation cores for advertisements by the participating individual members is 287, and total incentive provided to the participants is 5,340,000 won, in which an average provided money is 1,200 won. This information is managed by a score and class calculated according to criteria of the management system.

Table 12 shows total evaluation information for sellers.

TABLE 12
Total evaluation information for sellers

| | | | | | Social | | | |
|---|---|---|---|---|---|---|---|---|
| Seller | Advertisement | Sales | Introduction | Customer | contribution | | Total | Total |
| ID | score | score | page score | evaluation Score | score | . . . | score | class |
| CC01 | 230 | 547535 | 785 | 2540 | 541 | . . . | 24517 | 8 |
| CC02 | 34 | 245 | 45 | 248 | 14 | . . . | 108 | 17 |
| . . . | | | | | | | | |

The sales score is calculated by applying a business type- and region-specific correction value to the evaluation score of the selected advertisements or events, sales case number, sales amount, etc. The seller registering the introduction page calculates the sales score by applying a type-specific correction value to activity information on the introduction page, such as subscribed seller member, seller member activity state, visit number, seller answer, or information update. The customer evaluation score is calculated by applying a correction value to homepage visiting user's satisfaction and dissatisfaction number, a satisfaction and dissatisfaction ratio, a customer evaluation score, etc. The social contribution score is managed by applying a correction value to a needy neighbor assist, donation information, tax payment, etc.

The evaluation criteria of the seller are corrected according to each evaluation item, business type, and region based on a score within a certain period, so that fairness and reliability of the evaluation result is maintained.

Table 13 shows total evaluation information of individual members.

TABLE 13
Total evaluation information of individual members

| | Advertisement | Site | | | Social | | | | |
|---|---|---|---|---|---|---|---|---|---|
| Individual | participation | Use | Penalty | Purchase | contribution | | Reserve | Total | Total |
| ID | Score | Score | score | score | Score | . . . | (Won) | score | class |
| AAA | 120 | 257 | 5 | 2547 | 58 | . . . | 35200 | 852 | 5 |
| BBB | 85 | 150 | 2 | 2641 | 14 | . . . | 15000 | 398 | 8 |
| . . . | | | | | | | | | |

The score is calculated by applying a type-specific correction value to the calculated event participation score, management site visit number, goods and seller purchase opinion, and evaluation activity. Upon advertisement participation and site use, reservation penalty score, payment penalty score, or penalty score for unsuitable activity, such as sellers or goods dissatisfaction is calculated. The purchase score for payment information of the subscribed sellers or non-seller members is calculated, and the social contribution score such as needy neighbor assist or donated money, and money accumulated through the advertisement or event are managed.

When search conditions are the same upon searching advertisement objects, sellers, and goods using the total individual and seller information, the priorities is determined and the search result is listed according to the priorities.

While the invention has been shown and described with reference to certain exemplary embodiments thereof, it will be understood by those skilled in the art that various changes in form and details may be made therein without departing from the spirit and scope of the invention as defined by the appended claims.

1. An advertisement management and search system for allowing an advertisement requester to search for and select advertisement objects over a network, allowing the system to monitor the selected advertisement object viewing an advertisement and purchasing goods, represent the advertising process as a numerical value, determine advertisement cost based on the numerical value, and reflect the numerical advertisement result to scores of the advertisement object and the advertisement requester, and allowing all members or non-members to search for sellers and goods and the advertisement requester to search for advertisement objects based on the scores, the system comprising:
an information storing unit for storing information on individual or seller members, seller information, goods information, advertisement or event information, and result information for advertisement and purchase activities;
a search unit for allowing the advertisement requester to search for the advertisement objects and allowing the advertisement objects and all members or non-members to search for seller information, goods and advertisement, based on the information stored in the storing unit;
a selecting unit for allowing the advertisement requester to select the advertisement objects corresponding to an input search condition, the advertisement objects to select desired seller and goods advertisement, and ordinary users to search for and select desired sellers, goods, and advertisement;
a confirming unit for allowing the advertisement requester to confirm seller information, advertising state, type-specific participation state of the selected advertisement objects, and advertisement results, allowing all the members to confirm member information, advertising steps in which the members participate, and participation results, and allowing the members or non-members to conform the searched seller, goods, and advertisement information; and
an incentive providing unit for providing incentive to the advertisement objects according to the steps in which the advertisement objects participate.

2. The system of claim 1, further comprising a managing unit for managing, according to a data type, online activity information or information processed upon the advertisement objects participating in the advertisement, in addition to general information of subscribed members, by reflecting the information to the participation score of the advertisement object, and for managing, according to the data type, information input by the advertisement requester upon requesting the advertisement and information reflected upon the advertisement objects participating in the requested advertisement and goods by reflecting the information to the investment activity score, wherein:
the managing unit selectively or sequentially manages advertisement object participation steps including an object notification step, a detailed content confirmation step, a reservation step, a pre-payment step, a purchase step, a questionnaire step, in addition to general advertisement information, and the information is selected by the selection unit upon advertisement request and is used to calculate advertisement cost and determine an advertisement form.

3. The system of claim 2, wherein the managing unit allows the advertisement requester to search for and select desired advertisement objects, designate an object number, designate an advertising period and an object number in the period in consideration to features of sellers and goods, designate an advertisement object notification method, an advertisement reception confirmation method, and an advertising step, designate incentive and participation score of each designated step, designate reservation, pre-payment, and payment means, and participation conditions upon purchase including action information, a payment way, and a check way according to the designated advertising steps, and designate a questionnaire question number, a type, and a content when registering the advertisement, so that the advertisement requester selects various criteria according to the advertising steps, and wherein the advertisement requester checks advertisement cost calculated based on the designations, and requests to register the advertisement, and the managing unit checks validity of the input data to approve, cancel and supplement the requested advertisement depending on the advertisement content.

4. The system of claim 2, wherein the search unit allows the advertisement requester to search for and select the advertisement objects based on the information stored by the storing unit, allows the advertisement object to search for a desired advertisement, and allows all the members and non-members to search for and select sellers, goods information, or ongoing event information, and wherein when conditions input upon the advertisement requester searching for the advertisement objects are the same, preferential objects are selected based on the score of advertisement objects within the object number designated by the advertisement requester using the managing unit, and when there are several search results corresponding to the same search conditions upon all the members and non-members searching for the seller, goods, or advertisement information, the search results are listed according to priorities based on the seller score.

5. The system of claim 2, wherein the scores of the advertisement objects and the advertisement requester are values reflecting a participation degree of the members, and the managing unit gives a right for the score to the advertisement objects and the advertisement requester in order to induce participation of the advertisement objects and the advertisement requester, such that the advertisement objects and the advertisement requester obtain incentive corresponding to the scores, sell the scores to another member, or sell the scores within reference price through the management system upon withdrawal.

6. The system of claim 1, wherein the confirming unit notifies advertisement objects selected by the selecting unit that they are advertisement objects, and the advertisement objects participate the advertising steps designated by the advertisement requester, and follow a designated confirmation procedure for each step, and wherein when the confirmation is approved by the confirmation unit, the advertisement requester provides the designated incentive to the advertisement objects and reflects the participation score.

7. The system of claim 6, wherein the confirming unit confirms whether the advertisement objects participate in the purchase through advertisement object check in which, upon purchase, the advertisement objects directly register whether to purchase goods using an authentication number received from the advertisement requester according to action information as a participation condition designated by the advertisement requester, through advertisement requester check in which the advertisement requester accesses a management homepage to register that the advertisement objects participate, or through system check in which, upon purchase, payment information or goods information is provided by an affiliated company and registered, and provides incentive to the advertisement objects.

8. The system of claim 6, wherein the payment information paid by the incentive providing unit is reflected to expenditure specification of the advertisement objects and to revenue specification of the advertisement requester, so that the expenditure and revenue specifications are provided to the respective members, and wherein the payment information is modified, deleted or not opened in response to each member's request, purchase information within the advertising period and ordinary purchase information of all members are provided via the confirming unit, and the provided purchase or sales information is reflected to the scores of purchasing members and selling members by the managing unit to be applied and managed as a priority criterion.
